(19) United States
(12) Patent Application Publication
(10) Pub. No.: US 2008/0270594 A1
(43) Pub. Date: Oct. 30, 2008

(54) METHOD AND SYSTEM OF SEPARATE FILE STORAGE LOCATIONS AS UNIFIED FILE STORAGE

(76) Inventors: Charles M. McJILTON, Longmont, CO (US); David H. Hanes, Loveland, CO (US); Anthony J. Hernandez, Westminstor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,696

(22) Filed: Apr. 27, 2007

(51) Int. Cl. G06F 15/173

(52) U.S. Cl. 709/224

(57) ABSTRACT

Methods and systems of separate file storage locations as unified file storage. At least some of the illustrative embodiments are systems comprising a computer system coupled to a network, a first server coupled to the network (the first server provides a first file storage location), and a second server coupled to the network (the second server provides a second file storage location). The first server is configured to present the first file storage location and second file storage location as a unified storage location accessible through the first server.

### BACKGROUND

As home networks become more prevalent, so too does the need for centralized storage of data within the home. A home network attached storage device is a standalone device that couples to all the computer systems of the home by way of the home network, and the network attach storage device provides centralized data storage within the home. The centralized storage capacity of a home network attached storage device, while large, is also finite, and as additional storage space is needed the home user may be relegated to purchase and installation of a second home network attached device; however, having two (or more) home network attached storage devices forces the home users to be aware of which “centralized data storage” device stores particular data, and may further force the home user to manually migrate data to keep related data on the same storage device.

### BRIEF DESCRIPTION OF THE DRAWINGS

For a detailed description of exemplary embodiments of the invention, reference will now be made to the accompanying drawings in which:

FIG. 1 shows a computer system in accordance with at least some embodiments;

FIG. 2 shows a home network server in accordance with at least some embodiments;

FIG. 3 shows a method in accordance with at least some embodiments;

FIG. 4 shows a method in accordance with at least some embodiments; and

FIG. 5 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

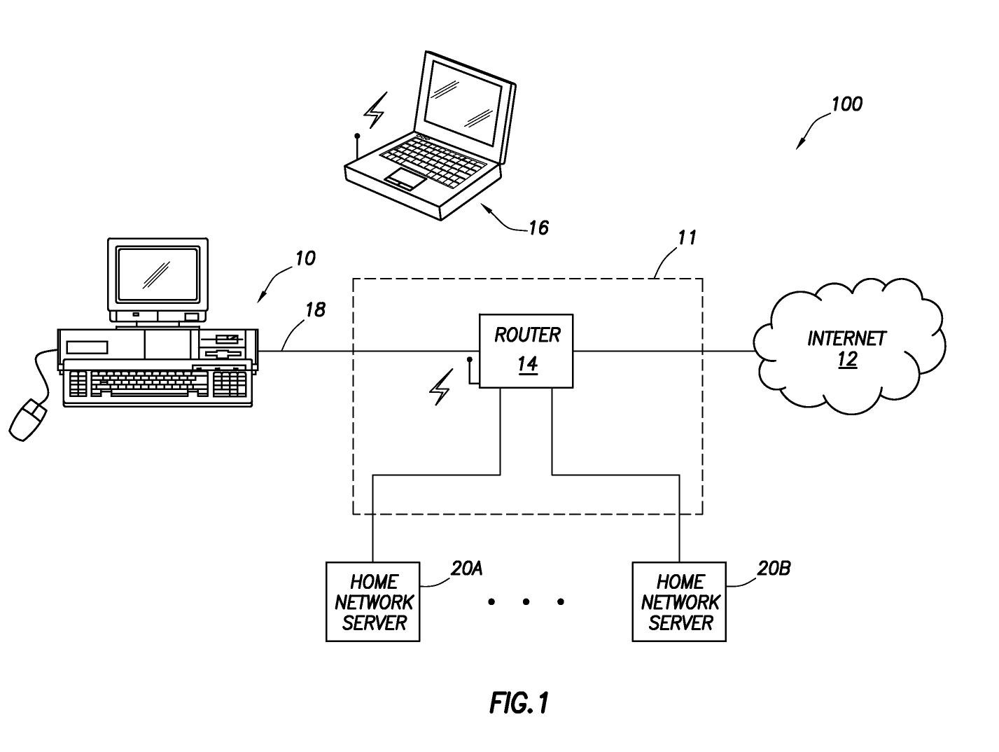

FIG. 1 illustrates a home networking system 100 in accordance with at least some embodiments. In particular, the home networking system 100 comprises an illustrative desktop computer system 10 coupled to the Internet 12 by way of network 11. Network 11 comprises cabling and devices (e.g., router 14) used to interconnect computer systems. The home networking system 100 also comprises a second computer system, in this case a portable computer 16 coupled to the Internet 12 by way of the network 11. In the embodiments illustrated in FIG. 1, desktop computer 10 couples to the illustrative router 14 of the network 11 by way of a hardwired connection 18 (e.g., an Ethernet connection) and illustrative portable computer 16 couples to the illustrative router 14 of network 11 wirelessly (e.g., IEEE 802.11, Bluetooth). However, computer systems may couple to the network in a hardwired fashion or wirelessly without regard to their portability. Further, while the system 100 of FIG. 1 shows only one desktop computer 10 and one portable computer 16, any number of computers may be coupled to the router using any networking functionality.

The home networking system 100 of FIG. 1 also comprises a plurality of home network server devices 20A and 20B, the home network severs 20 each independently couple to the network 11 (in the particular case of FIG. 1, to the router 14). Although only two home network servers are illustrated in FIG. 1, any number of home network servers 20 may reside within the home networking system 100. In accordance with at least some embodiments, each home network server 20 is a storage device and/or server available to any computer system of the home networking system 100 (e.g., desktop computer 10 or portable computer 16). Each home network server 20 may be, for example, the repository for data generated by computers of the home networking system 100. The storage implemented by each home network server 20 is accessible to other computer systems (e.g., desktop computer 10, portable computer 16, or another home network server) of the home networking system by way of any suitable currently available networking communication protocol (e.g., Internet Protocol (IP), Transmission Control Protocol/Internet Protocol (TCP/IP)), or any after-developed networking protocol.

Because each home network server 20 is designed to act as a server for the home networking system 100, and possibly to reduce cost, in accordance with at least some embodiments at least one home network server 20 does not support direct coupling of a display device and/or keyboard. Thus, in some embodiments at least one home network server 20 does not comprise a graphics controller that would couple to a display, and also does not comprise an input/output (I/O) controller that would couple to I/O devices such as a keyboard and mouse. To the extent administration is performed on each home network server 20, the administration may be done remotely using computer systems (e.g., desktop computer 10 or portable computer 16) in the home networking system 100.

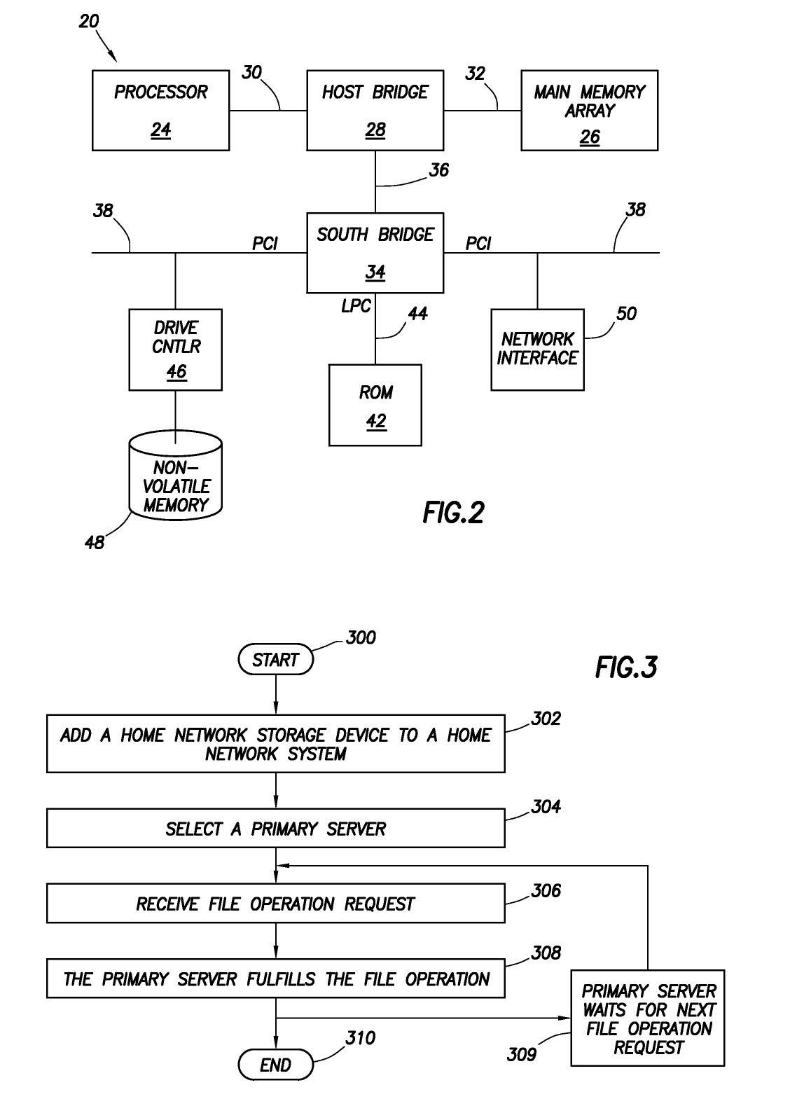

FIG. 2 illustrates in greater detail a home network server 20. In particular, each home network server comprises a processor 24 coupled to a main memory array 26, and various other components, through integrated host bridge 28 (sometimes referred to as a “north bridge” because of its location in computer system drawings). The processor 24 couples to the host bridge 28 by way of a host bus 30, or the host bridge 28 may be integrated into the processor 24. The processor 24 may be one of many available or after-developed processors, and thus the network attached storage device 20 may implement bus configurations or bus-bridges in addition to, or in place of, those shown in FIG. 2.

Main memory array 26 couples to the host bridge 28 through a memory bus 32. The host bridge 28 comprises a memory control unit that controls transactions to the main memory 26 by asserting control signals for memory accesses. The main memory array 26 functions as the working memory for the processor 24 and comprises a memory device or array of memory devices in which programs, instructions and data are stored. The main memory array 26 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM).

Still referring to FIG. 2, the home network server also comprises a second bridge 34 that bridges the primary expansion bus 36 to various secondary expansion buses, such as the peripheral component interconnect (PCI) bus 38. The second bridge 34 is sometimes referred to as the “south bridge” because of its location in computer system drawings. Read only memory (ROM) 42 couples to the south bridge 34, such as by a low pin count (LPC) bus 44. The ROM 42 contains software programs executable by the processor 24 to enable the system 20 to perform as a home network server.

Home network server 20 further comprises a drive controller 46 coupled to the south bridge 34 by way of the illustrative PCI bus 38. In alternative embodiments, the drive controller may couple to the primary expansion bus 36, or any other currently available or after-developed expansion bus. The drive controller 46 controls the non-volatile memory 48 of a long term storage device, such as a hard disk drive or optical drive. The term non-volatile memory may be alternatively referred to as a file storage location, storage space or storage capacity. In some embodiments, the home network server 20 implements a single long term storage device where computer systems of the home network can store and retrieve data and programs. In alternative embodiments, the home network server implements a redundant array of independent (or inexpensive) drive (RAID) system where the data and instructions written to the home network server 20 are duplicated across non-volatile memory devices to implement fault tolerance.

Also coupled to the illustrative PCI bus 38 is a network interface (NI) 50. The network interface 50 enables the home network server 20 to communicate with computer systems on the home networking system 100 (through the router 14, both of FIG. 1) such that the home network server 20 may act as a repository for data and programs of the home network system. As will be discussed more fully below, the network interface 50 also enables the home network server to communicate with other home network servers (e.g., enables home network server 20A to communicate with home network server 20B). In alternative embodiments, the functionality of the network interface 50 is integrated onto the motherboard along with the bridges 28 and 34.

Returning to FIG. 1. Consider, for purposes of explanation, a home networking system 100 substantially as illustrated in FIG. 1, except that only one home network server 20A is present. Home network server 20A may have several gigabytes or more of storage capacity, and thus a home networking system 100 may operate with a single home network server 20A for several years. However, when the storage capacity of the home network server 20A is full or substantially full, and the user is unable to internally expand the storage capacity of the home network server 20A, then the user may purchase and install a second home network server 20B. In accordance with the various embodiments, storage space provided by the non-volatile memory 48 of one home network server (e.g., server 20A), and the file storage provided by the non-volatile memory of another home network server (e.g., server 20B) are presented as a unified storage location to other computer systems (e.g., desktop computer 10 or portable computer 16). Further in accordance with various embodiments, the unified storage location is accessible for file operations by communication with only one of the home network servers 20.

In accordance with the various embodiments, home network servers 20A and 20B are configured to determine when a home network server has been newly installed in the home networking system 100, and the determination may take many forms. In some embodiments, at least one home network server 20 is configured to periodically scan locally coupled devices (i.e., devices coupled to the network 11) for the presence of previously unidentified home network servers. In other embodiments, each home network server 20 is configured to, as part of initial installation, send one or more network messages within the network 11 identifying itself as newly installed.

Regardless of the precise mechanism by which home network servers 20A and 20B identify each other within the home networking system 100, each home network server 20 is further configured to, as between the home network servers in the home networking system, select a primary server. The primary server becomes the single point of contact for computer systems in the home networking system for file operations. Selecting the primary server likewise may take many forms. In some embodiments, a user of a home network server is presented an option to manually select one of the home network servers as the primary server. In other embodiments, the selection of the primary server is accomplished without user input. Some illustrative examples of selection of a primary server are: each server generates a random number, and server with the highest number becomes the primary server; some or all the serial number of each server is compared, with the server with lowest serial number becoming primary server; or the server already existing within the home networking system is selected as the primary server, and additional servers are designated secondary servers. Moreover, the home network server selected as primary need not remain constant, and in fact the primary server may change periodically (either automatically, or based on a user selection), or when the primary server fails.

In accordance with the various embodiments, the primary server is the primary point of contact for file operations by computer systems in the home network system. The term “file operations” encompasses all file operations (e.g., file read, file write, file move, and file delete); however, the remaining portions of the specification are directed to file read and file write operations, as these operations are the primary operations implemented by home network servers. Consider first a request by one of the computer systems 10, 16 of the home networking system 100 to write a file to non-volatile memory. In accordance with the various embodiments, the requested location for storage of the file (e.g., F:\server\dadfiles\myfirstfile.doc) and the file are sent to the primary server over the network 11, and received over the primary server's network interface 50. The primary server has two options: store the file on its local non-volatile memory 48 or store the file on the non-volatile memory of a secondary server. In the event there is sufficient storage capacity on the non-volatile memory 48 of the primary server, and/or the primary server elects to store the file locally, the file is written to the non-volatile memory 48. If there is insufficient storage capacity on the non-volatile memory 48, and/or the primary server elects to store the file on a secondary server, the primary server makes a notation as to the location of the file (e.g., in a database or table) and forwards the file using its network interface 50 over the network 11 to a secondary server. The secondary server receives the file over the network 11 and through its network interface 50, and stores the file on the non-volatile memory of the secondary server. Thus, home networking system 100 uses the same network 11 as both the mechanism to send file operation requests from computer systems 10, 16 to home network servers 20, and also as the network on which storage commands are communicated between home network servers 20.

The actual name and location of the stored file need not be as indicated by the requesting computer system. With respect to files stored in the non-volatile memory of the primary server, the file may indeed be in the requested directory and with the requested name, or the file may be stored in any convenient location in the non-volatile memory with any name (with the notation in the database or table correlating the requested name to the actual name). Likewise with respect to storage of the file on the non-volatile memory of the secondary server, the file may be in the requested directory with the requested name, or the file may be stored in any convenient location in the non-volatile memory with any name. In the case of storage on the secondary server, the notation in the database or table of the primary server may be the primary tracking mechanism, and thus in some embodiments secondary server stores the file at a location requested by the primary server without knowing the location or name requested by the requesting computer system. In embodiments where the secondary server may take over as the primary server, the database or table that correlates file names to actual storage locations may be maintained at both the primary and secondary servers.

Now consider a request by one of the computer systems 10, 16 of the home networking system 100 to be provided a file stored on the one of the home network servers 20. In accordance with the various embodiments, the requested location/name of the file (e.g., F:\server\dadfiles\myfirstfile.doc) is sent to the primary server. The primary server may or may not have the file stored on its non-volatile memory, and thus the primary server determines whether the requested filed is stored on its non-volatile memory. In some embodiments, the determination is made by inspecting the non-volatile memory at the requested location (in this example F:\server\dadfiles\). In other embodiments, the primary server consults the database or table to determine if the requested file is locally stored. In the event the file is locally stored, then the primary server sends the file to the requesting computer system.

In the event the requested file is not stored on the non-volatile memory of the primary server, but is instead stored on a secondary server (e.g., determined by consulting the database or table), then the primary server sends a request to the secondary server to provide the file. Providing the file by the secondary server may take several forms. In some embodiments, the secondary server forwards the requested file to the primary server, and the primary server in turn forwards the requested file to the requesting computer system. In yet other embodiments, when the primary server sends a command to the secondary server to provide the file, the primary server also sends an indication of the requesting computer system. Thus, in some embodiments the secondary server forwards the file directly to the requesting computer system.

Utilizing a system as described provides a seamless mechanism to add storage capacity to the home network system 100 without concern regarding actual locations of files. Files may appear to reside within the same drive and directory, yet in actuality the file locations may span different home network servers. Consider, for example, that a primary server has limited additional non-volatile memory, but the primary server stores the file F:\server\dadfiles\myfirstfile.doc. Now consider that a user of one of the computer systems 10, 16 desires to store a second file in the same directory, such as F:\server\dadfiles\mysecondfile.doc. Because of the limited storage capacity of the primary server, the “mysecondfile.doc” may be stored on a secondary server, but from the perspective of the user of the computer systems 10, 16 the files are in the same drive and directory.

Implementation of the various embodiments discussed above may take many forms. In some embodiments, fulfilling file operations as discussed may be implemented as part of the operating system executed on each home network server 20. That is, file operation requests received by a home network server 20 are passed to a portion of the operating system. The operating system, in turn, acts as a primary server or a secondary server to fulfill the file operations as discussed above. In yet other embodiments, fulfilling file operation requests as discussed above is accomplished by a user-level program operating within the home network server, but not as part of the operating system. The user-level program makes the determinations as to file storage locations, and passes only file-level operations to the operating system.

FIG. 3 illustrates a method (e.g., software) in accordance with at least some embodiments. In particular, the method starts (block 300) and proceeds to add a second home network storage device to a home networking system (block 302). In accordance with the various embodiments, the second home network storage device couples directly to the network, and from a hardware perspective may be a substantial duplicate of a home network server already coupled within the home networking system. After coupling the second home network server to the network, one of the home network servers is selected as the primary server (block 304). Selection of a primary server may be performed manually (e.g., by a user of one of the computer systems of the home networking system), or the two home network servers may arbitrate between themselves to select a primary server. After installation and selection of a primary server, file operation requests from computer systems 10, 16 are received by the primary server (block 306). Receipt of the file operation request may be by way of an operating system program, or the receipt may be by way of a “server application” executing on top of the operating system of the primary server. The primary server fulfills the file operation (block 308), even if the file operation is with respect to a file storage location on the secondary server. In some respects, the illustrate method ends (block 310) and the server 20 performs other functions; however, the primary server may also wait for the next file operation request (block 309), and when the next file operation request arrives the illustrative method returns to receiving the file operation request (block 306).

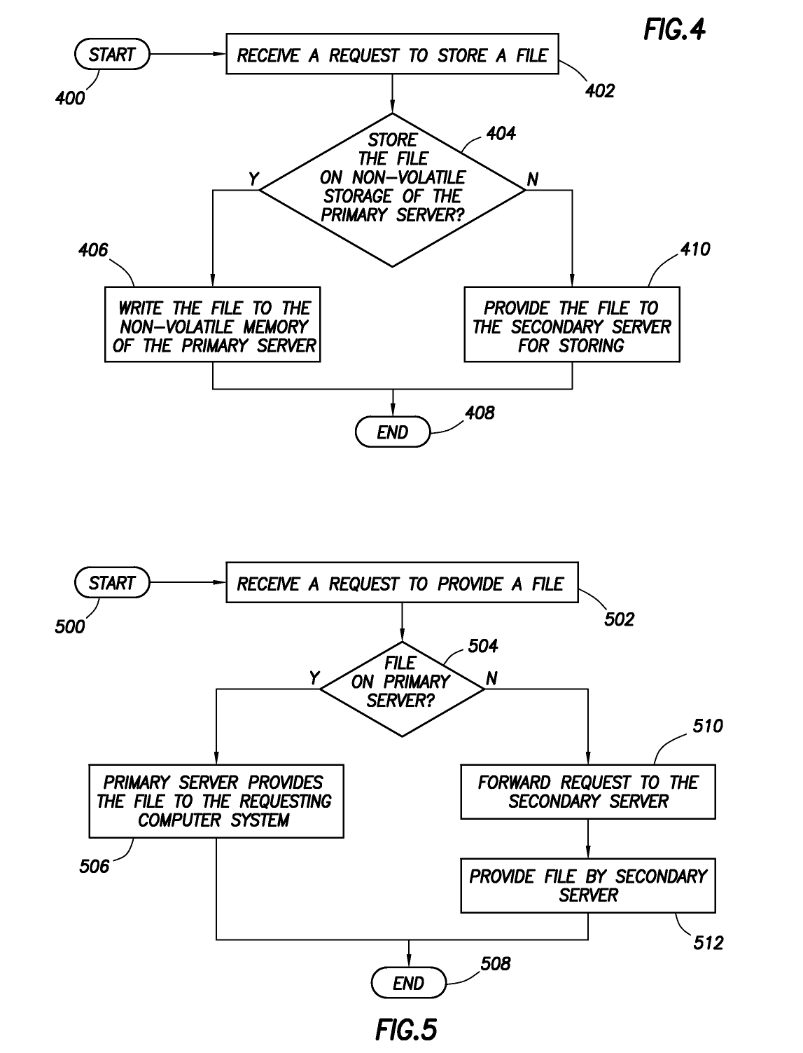

FIG. 4 illustrates a method (e.g., software) in accordance with further embodiments. In particular, FIG. 4 illustrates a flow diagram with respect to file write operations. In particular, the method starts (block 400) and proceeds to the receipt of a request to store a file (block 402). Receiving a request to store a file is a specific example of a file operation request (as discussed in FIG. 3, block 306). In response to the request to store a file, the primary server makes a determination of whether to store the file on non-volatile storage of the primary server, or to store the file on non-volatile storage of a secondary server (block 404). The determination may be based on a host of criterion. For example, if a previous version of the file already exists on the primary server, then the particular request to store the file may overwrite the previous version on the non-volatile memory of the primary server. Likewise, if the non-volatile memory of the primary server has sufficient file storage capacity, then the file may be stored on the non-volatile storage of the primary server without regard to existence of previous versions. Similarly, if a previous version of the file exists on a secondary server, or if the primary server has insufficient file storage capacity to store the file, then the primary server may elect to store the file on the non-volatile memory of the secondary server. If the primary server elects to store the file locally, then the illustrative method writes the file to the non-volatile memory of the primary server (block 406), and the method ends (block 408). Likewise, if the primary server elects to store the file on the secondary server, then the illustrative method provides the file to the secondary server for storing (block 410), and the method ends (block 408).

FIG. 5 illustrates a method (e.g., software) in accordance with further embodiments. In particular, FIG. 5 illustrates a flow diagram with respect to requests from computer systems 10, 16 to provide a file stored on one of the home network servers. In particular, the method starts (block 500) and proceeds to the receipt of a request to provide a file (block 502). Receiving a request to provide a file is a specific example of a file operation request (as discussed in FIG. 3, block 306). In response to the request to provide a file, the primary server makes a determination as to the location of the file (block 504). Making a determination as to the location of the file may take many forms. In some embodiments, the primary server searches its non-volatile memory for the file, and if the file is not found the primary server checks for the presence of the file on the secondary servers. In other embodiments, the primary server consults a database or table that correlates file names to locations of the files. In yet still other embodiments, the primary server may search its non-volatile storage, and if the file is not found the primary server may then consult the database or table. Regardless of the precise mechanism used to determine the file location, if the file is located on the non-volatile storage of the primary server, the primary server provides the file to the requesting computer system (block 506), and the process ends (block 508). If, however, the requested file resides on a secondary server, the primary server forwards the request for the file to the secondary server (block 510). The secondary server provides the file (block 512), and the process ends (block 508). In some embodiments, the secondary server forwards the file to the primary server, which then forwards the file to the requesting computer system (e.g., in cases where the requesting computer system implements a firewall which blocks uninitiated contacts), and in other embodiments the secondary server sends the requested file directly to the requesting computer system.

From the description provided herein, those skilled in the art are readily able to combine software created as described with appropriate general purpose or special purpose computer software to create a computer system and/or computer subcomponents in accordance with the various embodiments, to create a computer system and/or computer subcomponents for carrying out the methods of the various embodiments and/or to create a computer-readable media for storing a software program (e.g., an operating system) to implement the method aspects of the various embodiments.

What is claimed is:

1. A system comprising:
a computer system coupled to a network;
a first server coupled to the network, the first server provides a first file storage location;
a second server coupled to the network, the second server provides a second file storage location;
wherein the first server is configured to present the first file storage location and second file storage location as a unified storage location accessible through the first server.

2. The system according to claim 1 wherein the first server is configured to receive a request from the computer system to store a file, and wherein the first server is configured to selectively write the file to the first file storage location or write the file to the second file storage location.

3. The system according to claim 1 further comprising:
wherein the first server is configured to receive a request to provide a file;
wherein the first server is configured to determine whether the file is stored in the first or second file storage location; and
wherein the first server is further configured to provide the file to the computer system regardless of whether stored on the first or second server.

4. The system according to claim 1 further comprising:
wherein the first server is configured to receive a request to provide a file;
wherein the first server is configured to determine whether the file is stored in the first or second file storage location; and
wherein the first server is configured to direct the second server to send the file to the computer system if the file is stored on the second file storage location.

5. A computer-readable medium storing a program that, when executed by a processor, causes the processor to:
provide an operating system for a first server;
receive a request for file operations from a remote computer system, the request received over a network connection; and
fulfill the request for file operations using storage space comprising storage space on the first server and storage space on a second server coupled to the first server over the network connection.

6. The computer-readable medium according to claim 5 further comprising:
wherein when the processor receives the request, the program causes the processor to receive a request to store a file; and
wherein when the processor fulfills the request, the program causes the processor to selectively write the file to the storage space on the first server or write the file to storage space on the second server.

7. The computer-readable medium according to claim 5 further comprising:
wherein when the processor receives the request, the program causes the processor to receive a request to provide a file; and
wherein when the processor fulfills the request, the program causes the processor to:
determine whether the file is stored in the storage space of the first server or the storage space of the second server; and
provide the file to the remote computer system from the storage space of the first server if the file is stored on storage space of the first server, or retrieve the file from the second server and provide the file to the remote computer system if the file is stored on the storage space of the second server.

8. The computer-readable medium according to claim 5 further comprising:
wherein when the processor receives the request, the program causes the processor to receive a request to provide a file; and
wherein when the processor fulfills the request, the program causes the processor to:
determine whether the file is stored in the storage space of the first server or the storage space of the second server; and
provide the file to the remote computer system from the first server if the file is stored on the first server, or direct the second server to send the file to the remote computer system.

9. The computer-readable medium according to claim 5 wherein the program further causes the processor to:
communicate with the second server; and
choose one of the first server or second server to operate a primary server for file operations.

10. A server comprising:
a processor;
a non-volatile storage device coupled to the processor;
a network interface coupled to the processor;
wherein the server is configured to receive a request for file operations from a remote computer system over the network interface; and
wherein the server is configured to carry out the request for file operations from the non-volatile storage device, and the server is configured carry out the request for file operations from a storage device on a remote server coupled to the server over the network interface.

11. The server according to claim 10 wherein the server is configured to receive a request from the remote computer system to store a file, and wherein the server is configured to selectively write the file to the non-volatile storage device or write the file to the storage device on the remote server.

12. The server according to claim 10 further comprising:
wherein the server is configured to receive a request to provide a file; and
wherein the server is configured to determine whether the file is stored in the non-volatile storage device or the storage device on the remote server, and the server is further configured to provide the file to the remote computer system.

13. The server according to claim 10 further comprising:
wherein the server is configured to receive a request to provide a file; and
wherein the server is configured to determine whether the file is stored on the non-volatile storage device or storage device on the remote server; and
wherein the server is configured at least one selected from the group consisting of: send the file to the computer system if the file is stored on the non-volatile storage device; and direct the remote server to send the file to the computer system if the file is stored on the storage device on the remote server.

14. A method comprising:
sending a request for a file operation to a primary server over a network;
determining by the primary server that the file operation is directed to non-volatile memory of a secondary server coupled to the primary server over the network;
fulfilling the request for file operation by the primary server.

15. The method according to claim 14 wherein fulfilling the request further comprises sending a command by the primary server to the secondary server to write a file to the non-volatile memory of the secondary server.

16. The method according to claim 14 wherein determining further comprises inspecting a database stored on the primary server.

17. The method according to claim 14 further comprising:
wherein sending the request further comprises sending a request to provide a file; and
wherein fulfilling the request further comprises:
directing the secondary server to send the file to the primary server; and
forwarding the file to a requesting computer by the primary server.

18. The method according to claim 14 further comprising:
wherein sending the request further comprises sending a request to provide a file; and
wherein fulfilling the request further comprises directing the secondary server to send the file to a requesting computer.
